(19) United States
(12) Patent Application Publication
(10) Pub. No.: US 2024/0285981 A1
(43) Pub. Date: Aug. 29, 2024

(54) CONTROLLED DESCENT SAFETY SYSTEMS AND METHODS

(71) Applicant: Bailout Systems, Inc., Cincinnati, OH (US)

(72) Inventors: Benjamin T. Krupp, Wyoming, OH (US); Haskell Simpkins, Cincinnati, OH (US)

(21) Appl. No.: 18/377,638

(22) Filed: Oct. 6, 2023

Related U.S. Application Data
(60) Provisional application No. 63/414,327, filed on Oct. 7, 2022.

(51) Int. Cl. A62B 1/08; A62B 1/14; H02K 49/04

(52) U.S. Cl. CPC A62B 1/08; A62B 1/14; H02K 49/046

(57) ABSTRACT

A velocity control device for controlling the velocity of a load on a flexible tension member. The device can include a housing having a housing peripheral surface, with a portion of the housing peripheral surface defining an exit opening. The device can also include a phasing induction brake, the phasing induction brake being adjustable to control flux density in a magnetic circuit.

### REFERENCE TO RELATED APPLICATIONS

This application claims priority to U.S. Provisional Application No. 63/414,327, filed on Oct. 7, 2022, the disclosure of which is incorporated by reference herein in its entirety.

### TECHNICAL FIELD

Embodiments of the technology relate, in general, to controlled velocity devices, and in particular to personal controlled descent control devices.

### BACKGROUND

There arise situations when a line-constrained load should experience a controlled velocity. For example, in an emergency situation, such as during a fire in a tall building, escape from an elevated position becomes necessary, such as by exiting a window in an upper floor of the building. Use of a standard descent rope to escape from an elevated position is extremely dangerous, particularly to those not versed in rappelling techniques, where providing an improved safety device would be advantageous.

### BRIEF DESCRIPTION OF THE DRAWINGS

FIG. 1 is a perspective view of a controlled descent device according to one embodiment.

FIG. 2 is a perspective view of a controlled descent device according to one embodiment.

FIG. 3 is perspective view of a controlled descent device according to one embodiment.

FIG. 4 is a side elevation view of a portion of the controlled descent device of FIG. 3.

FIG. 5 is a cross-sectional view of Section 5-5 in FIG. 4.

FIG. 6 is a side elevation view of a portion of the controlled descent device of FIG. 3.

FIG. 7 is a cross-sectional view of Section 7-7 in FIG. 4.

### DETAILED DESCRIPTION

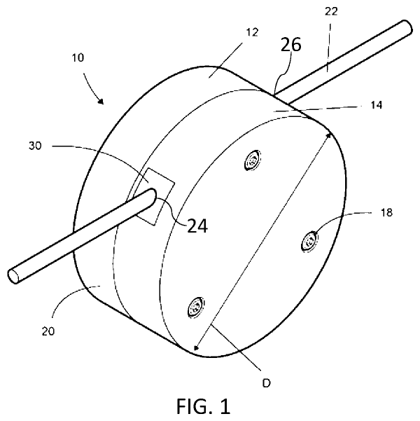

Certain embodiments are hereinafter described in detail in connection with the views and examples of FIGS. 1-7, wherein like numbers refer to like elements throughout the views.

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The device disclosed herein is useful as a load lowering velocity controller. However, the device can operate broadly as a velocity control mechanism for any load experiencing a force tending to move or accelerate it. For example, the device disclosed herein can be used to control the velocity of an ascending load, for example, an ascending weather balloon. Likewise, the device disclosed herein can be used to control the relative velocity of a laterally moving vehicle, for example, a trailer that has come loose from a towing vehicle. The device will be disclosed in detail herein as a load lowering velocity controller of the type useful in lowering people out of buildings in emergency situations.

Controlled descent from emergency situations may be accomplished by a skilled practitioner, such as a firefighter, trained in rappelling. To an untrained, young, or infirm individual, exiting an emergency situation with only a rope can be extremely dangerous. Additionally, even trained responders, such as firefighters, may find themselves in situations where they are injured, carrying additional weight such as while rescuing others, or lacking the equipment necessary for a controlled descent. Further, the practitioner may have to use his or her hands during the descent to operate equipment such as a firearm or manipulate themselves or another payload. The controlled descent device disclosed herein can be utilized in a hands-free operation by trained and untrained persons alike.

Embodiments described herein can be less expensive, have less mass, be less bulky, and can be easier to maintain than powered winches or other existing safety systems. Embodiments described herein may be useful in power outages, such as those frequently occurring during fires or disasters, where an external power source may not be available. Embodiments described herein can be operated automatically, without hand braking, in a compact and cost-effective manner. Embodiments of the system can be used for a variety of different weights of users without the need to adjust for different weights. For example, any firefighter within an average weight range could attach a device described herein and use the device to safely descend from a building without being required to manipulate the device based on his or her weight or otherwise tailor the system. In an embodiment, a device described herein can be designed based on other factors related to weight, such as the waist size or the clothing sizes of a user. In general, it is contemplated that controlled descent devices can be designed and manufactured for predetermined load ranges, including weight ranges for persons such as firefighters.

In accordance with an example embodiment, the controlled descent device can be permanently mounted in strategic locations. In an example, a device can be ready for use by a user who clips himself onto a free end of the flexible tension member associated with the device.

In an embodiment, the device disclosed herein, except for a flexible tension member moving through it as disclosed below, has no moving parts. That is, in an embodiment the load lowering descent controller disclosed herein operates in-use of the absence of any springs, stators, rotating magnets, or any other moving parts. As disclosed below, certain parts may be removable, changeable, and modifiable when the device is not in use, but once set for use, in an embodiment there are no moving parts, and no parts move during use.

In an embodiment, the device disclosed herein can utilize moving parts to adjust the velocity control profile, prior to or during use. Moving parts can be used to manipulate the gain of a capstan or the force generated by the throttle 30. Parts can be moved by way of user input, or by mechanisms powered from the kinetic energy of the payload, or actuated by forces present in the device, such as tensile force in the flexible tension member. In an embodiment, the device disclosed here in can be used by a person without the person interacting with the device in any way to effect controlled descent. That is, the device can be operable for use in lowering a load, such as a person, in a controlled manner with the person not needing to manipulate the device for it to work properly. In an embodiment, for example, an untrained person, and even an unconscious person, can be lowered at a controlled velocity in a controlled manner using the device disclosed herein. As used herein, “controlled descent” includes constant velocity translation of an object, including constant velocity descent of a load under the force of gravity.

As described herein, the device can be a relatively compact design suitable for attachment and operation from a belt, harness, or bodice, or other suitable load distributing garment of a wearer. Additionally, the device can be substantially enclosed and protected from the elements for operation in harsh environments.

Referring to FIG. 1, disclosed is one embodiment of a controlled descent device 10 having a housing 12. The housing may be any structure for mounting and/or protecting a capstan, i.e., a rotating pulley-like structure that can be used to control the frictionally engaged motion of a flexible tension member 22. In an embodiment, the capstan can be a simple pulley, such as the pulley shown as capstan 120 in FIGS. 5 and 7. The housing 12 can be made of two or more parts joined together to make an enclosure for a capstan 120, around which the flexible tension member 22 can be at least partially wrapped. A housing cover 14 can be joined to the housing 12 in any suitable manner, including screw connections 18 as shown in FIG. 1. The housing cover 14 of the housing 12 can have joined thereto the capstan 120. By way of example, the capstan 120 can be integral with another part, for example the housing 12, the housing 12 and capstan 120 can be machined out of a single piece of suitable material, such as aluminum for example. In an embodiment, the capstan 120 could be partitioned into multiple parts, with a portion of the capstan 120 being integral to the housing 12 and the remaining portion integral to the housing cover 14.

While the housing 12 shown in FIG. 1 has a cylindrical shape, the housing 12 can be other shapes, including generally rectangular, or box-shaped, pentagonal, hexagonal, octagonal, and other polygonal shapes, organic shapes such as those defined with Bayesian surfaces. The overall shape of the housing 12 can be designed in any shape and size suitable for the use for which it is intended. For example, the size and shape can be dependent on the size of the flexible tension member 22 needed for the load for which velocity control is desired. If the device 10 is intended to be worn as a personnel descent controller for firefighters, utilizing a flexible tension member 22 designed for typical loads of a firefighter and his or her equipment, the size and shape can be designed for relatively compact attachment to the firefighter's safety harness, turnout gear, self-contained breather apparatus, or other attachment, and can be nominally about 3 inches in diameter. While the overall size of device 10 may not be limited, in general, for personal, harness-attached uses, the largest dimension of a face of the housing 12, for example the diameter, can be from about 1.5 inches to about 6 inches. Likewise, if the shape of the housing 12 were generally a rectangular box shape, the largest side dimension of the housing 12 could be from about 1.5 inch to about 6 inches. In an embodiment the largest dimension of a face of the housing 12 can be from 2 inches to about 4 inches. In an embodiment, the largest dimension of a face of the housing 12 can be from about 5 inches to about 16 inches. In like manner, a housing width, W, as measured from an external surface of housing 12 to an external face of housing cover 14 can be from about 0.5 inches to about 6 inches and can be from about 1 inch to about 3 inches. Larger dimensions, while potentially not convenient for wearable personal emergency use can be utilized.

The housing 12 can be made of any material of suitable durability for the conditions of the intended use of the controlled descent device 10. In an embodiment the housing 12 can be made any suitable engineering structural material such as, but not limited to materials including polymers, metals, ceramics, fiberglass, carbon fiber, or organics such as wood.

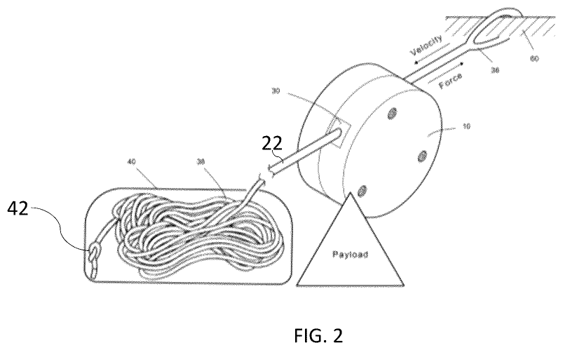

The housing 12 can have on an outer periphery 20 thereof two openings through which a flexible tension member 22 can pass through during operation. In an embodiment, the openings can be portions of the housing 12 in which the flexible tension member 22 can pass. In an embodiment, the openings can include an entry aperture 24 and an exit aperture 26, as depicted in FIG. 2. The flexible tension member 22 can be, but is not limited to, an organic or polymer-based fiber cord, rope, cable, webbing, coated cables, carbon fiber, composite material, homogenous material such as a steel band, or other flexible load bearing line suitable for the application. The size and type of flexible tension member 22 can be selected for the conditions of the intended use of the controlled descent device 10. For use as a personnel descent controller for firefighters, for example, the flexible tension member 22 can be any tension member certified by the National Fire Protection Association (NFPA), or equivalent international regulatory body, such as Conformité Européene (CE) in Europe. The size and shape of the entry aperture 24 and the exit aperture 26, as well as the size and shape of the throttle 30 can be determined by the cross-sectional dimension, e.g., the diameter, or stiffness of the flexible tension member 22 used with the controlled descent device 10.

Referring now to FIG. 2, in operation, flexible tension member 22 can be anchored to a relatively fixed location by an anchor 36 which can be any suitable configuration of the flexible tension member 22 or additional apparatus. For example, the anchor 36 can be a simple loop of the flexible tension member 22 at a first end of the flexible tension member 22, with the loop being adapted to be secured to a relatively fixed location, such as to a post or beam in a building. The anchor 36 can be, or can incorporate, hooks, grapples, or the like intended for fixedly attaching to a relatively fixed location. For example, anchor 36 can be a loop of the flexible tension member completed by a clip, carabiner, axe, or other firefighting equipment, or the like after being wrapped around a beam of a building, as represented by 60 in FIG. 2. A portion of the flexible tension member 22, including the other, second, end of the flexible tension member 22 can be stored appropriately for use, for example in a coil 38 inside a storage compartment 40. In operation, the coil 38 can be any suitable arrangement that permits the flexible tension member 22 to leave the storage compartment 40 during operation without bunching, or knotting up, and thereby preventing the flexible tension member 22 from traversing throttle 30 in the intended manner. Storage compartment 40 can be a bag, box, or other compartment in which flexible tension member 22 can be coiled for use. In an embodiment, a safety stop 42 can be disposed at an end of flexible tension member 22 so that if the entire length of flexible tension member 22 attempts to pass through throttle 30, the safety stop 42 would prevent any further motion of the flexible tension member 22 through the throttle 30, thereby effectively preventing the flexible tension member 22 from becoming detached from the device 10.

In an embodiment, energy transformation stages can be utilized, for example energy transformation pre- or post- the disclosed device 10. The magnetic phasing disclosed herein can be used to produce a system mechanical gain, such that when a payload is attached to the controlled descent device 10 and the payload and the controlled descent device 10 begin to descend such that the flexible tension member 22 begins to enter the controlled descent device 10 through the entry aperture 24 and traverse the capstan 120, a relatively small oppositely directed force on the flexible tension member 22 can effectively limit, including slowing, and including stopping, the descent of the payload connected to the controlled descent device 10. In an embodiment, the number of complete or partial wraps of the flexible tension member 22 about capstan 120 produces a quantifiable mechanical advantage. The controlled descent device 10 can be designed for a predetermined load by constructing the controlled descent device 10 to have a predetermined number of wraps or partial wraps of the flexible tension member 22 about the capstan 120, and using magnetic phasing to “fine tune,” so to speak the operation of the controlled descent device 10, as disclosed more fully below.

Continuing to refer to FIG. 2, one mode of operation is schematically illustrated, in which the payload may be connected to the controlled descent device 10. In the mode illustrated in FIG. 2, the anchor 36 at a first end of flexible tension member 22 can be secured to a relatively rigid object, shown in FIG. 2 as reference object 60. In operation, controlled descent device 10 can be attached to a payload, which can be a person, for example by attaching in any suitable manner to a belt or harness of the person. Thus, a firefighter can be the payload, and the firefighter can have attached to his or her harness or belt the controlled descent device 10. If the payload, that is, the firefighter, becomes subject to the forces of gravity in free fall, the controlled descent device 10 attached to the firefighter will begin to descend and the flexible tension member 22 stored in storage compartment 40, such as in a coil 38 will begin to traverse through the descent device 10. Fire-rated rope can have a relatively high specific heat capacity and a significant mass per unit length, allowing the flexible tension member 22 to absorb a sizable portion of the dissipated energy. The energy absorbed by the flexible tension member 22 can be quickly removed from the device 10, allowing it to maintain safe operating temperatures during descent. As the payload with the attached controlled descent device 10 continues to be attracted to the ground by the force of gravity, in effect the flexible tension member 22 continues to be drawn into controlled descent device 10, around capstan 120 while then exiting the controlled descent device 10.

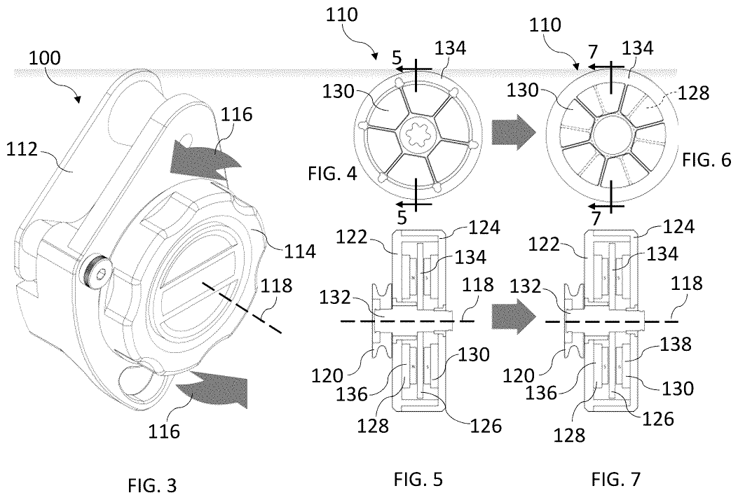

Referring to FIGS. 3-7, there is disclosed schematically one embodiment of a mechanism for controlling the rate at which the flexible member 22, as depicted in FIG. 1, can pass through the controlled descent device. Shown in FIG. 3 is a controlled descent device 100 in which a flexible tension member 22 (not shown) can be suitably arranged to enter one portion and exit another portion of the device 100. The controlled descent device 100 can have a housing 112 and an external rotatable member 114, such as a knob suitable for gripping and rotating about a central axis 118, such as in the direction indicated by arrows 116.

Interior to the controlled descent device 100, as shown in FIGS. 4 and 6 may be a phasing induction brake 110 which can be used to adjust the drag force imparted to a flexible tension member 22 on a capstan 120 that may be rotatable about the central axis 118, as more clearly depicted in the cross-sectional diagrams of FIGS. 5 and 7. The capstan 120 may be mounted to a shaft 132. Also joined to shaft 132 may be a non-ferrous, electrically conductive plate 134 (such as aluminum or copper) in the shape of a round disc. In operation, as the capstan 120 rotates about the central axis 118 the conductive plate 134 rotates with it, as each are joined to the shaft 132.

The conductive plate 134 may be part of the phasing induction brake 110 and may be used to control the flux density in a magnetic circuit achieved by the placement of magnets mounted radially about the shaft 132 and spaced apart in an air gap in which the conductive plate 132 rotates. A first set of magnets 128 are mounted on a first induction brake housing portion 122. A second set of magnets 130 are mounted on a second induction brake housing portion 124. The first induction brake housing portion 122 and the second induction brake housing portion 124 do not rotate with shaft 132, but one or both can be rotatable about the shaft 132. In an embodiment, the first induction brake housing portion 122 may be fixed and cannot rotate, and the second induction brake housing portion 124 can be rotated about the shaft 132 by rotation of the knob 114.

As can be understood from this description and reference to FIGS. 5 and 7, the phasing induction brake 110 can be schematically described in an embodiment as three operationally adjacent layers:

First outside layer: Three magnets 128 mounted radially, equally spaced, on the first induction brake housing portion 122. The three magnets 128 can be mounted on a first-round disc 136 having a first diameter and being made of highly permeable magnetic material such as low carbon steel (e.g., back iron). Each of the magnets 128 contain a North and South Pole (e.g., Pole Pair).

Second outside layer: Three magnets 130 mounted radially, equally spaced, on the on the second induction brake housing portion 124. The three magnets 130 can be mounted on a second-round disc 138 having a second diameter and being made of a piece of highly permeable magnetic material such as low carbon steel (e.g., back iron). Each of the magnets 130 contains a North and South Pole (e.g., pole pair).

Middle layer: The conductive plate 134, which may be a non-ferrous, electrically conductive round disc (such as aluminum or copper) that has a third diameter greater than the first diameter or the second diameter of the first and second round discs 136 and 138, respectively. The diameter of the conductive plate 134 extends sufficient radially beyond either of the first and second round discs 136 and 138, e.g., the back iron members, suitably to prevent flux leakage.

The first and second layers are coupled by a mechanism that allows the relative angle (clocking position) to be varied continuously over a range (e.g., Phase Angle). At phase angle equal to zero, as depicted in FIG. 4, the pole pairs on the top are anti-aligned to the pole pairs on the bottom. When anti-aligned (e.g., North to South) the attractive force from one side to the other can be maximized. Also, the magnetic flux through the middle layer (e.g., the induction target) can be maximized. The drag torque produced by the induction brake 110 may be proportional to the relative velocity between the coupled first and second layers (e.g., the magnet array) and the independent middle layer (the induction target). A relatively minor change in magnet alignment (e.g., phase), as depicted in FIG. 6, provides a relatively substantial change in the total torque output of the induction brake 110. Further phasing the first and second layers 136 and 138 controls the responsiveness (rate of change of torque) of the induction brake 110, which can be referred to as the “gain” in the system. When used in conjunction with a capstan 120, the gain of the induction drive can be amplified according to an exponential function of wrap angle of the flexible tension member 22 around the capstan 120. The capstan 120 enables a relatively small induction brake 110 to produce a relatively large drag torque that can be proportional to the relative velocity of the top/bottom to middle layers. The operator then can control the descent speed by minor changes in the magnet alignment, causing substantial changes in the drag torque.

There are additional ways of controlling flux density on the fly. These other methods can be used independently or in parallel with phasing induction brake 110 to achieve the ideal system response. For example, flux density can be changed by increasing or decreasing air gaps in the magnetic circuit and/or by reducing the magnetic permeability in the magnetic circuit or by changing the strength of an electromagnetic circuit by changing the electrical current delivered to the electromagnet.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope be defined by the claims appended hereto.

What is claimed is:

1. A controlled descent device, comprising,
a capstan mounted upon a rotatable shaft having a central axis,
a non-ferrous, electrically conductive plate joined to the rotatable shaft, the conductive plate having a first side and a second side, and
a first plurality of magnets mounted on a first brake housing mounted in a first spaced relationship with the first side of the conductive plate and a second plurality of magnets mounted on a second brake housing mounted in a second spaced relationship with the second side of the conductive plate, wherein the first brake housing and the second brake housing are independently joined to the rotatable shaft and one of the first brake housing and the second brake housing is rotatably joined to the rotatable shaft.

2. The controlled descent device of claim 1, wherein the conductive plate is in a shape of a disc.

3. The controlled descent device of claim 1, wherein the first plurality of magnets are mounted on the first brake housing by being joined to a first disc of magnetic material, the first disc of magnetic material being joined to the first brake housing.

4. The controlled descent device of claim 1, wherein the second plurality of magnets are mounted on the second brake housing by being joined to a second disc of magnetic material, the second disc of magnetic material being joined to the second brake housing.

5. The controlled descent device of claim 1, wherein the first plurality of magnets comprises three stationary magnets, each of the three stationary magnets having a north and a south pole, the three stationary magnets being mounted radially and equally spaced about the central axis.

6. The controlled descent device of claim 1, wherein the second plurality of magnets comprises three rotatable magnets, each of the three rotatable magnets having a north and a south pole, the three rotatable magnets being mounted in radially equally spaced relationship about the central axis.

7. The controlled descent device of claim 3, wherein the first disc of magnetic material is made of low carbon steel.

8. The controlled descent device of claim 4, wherein the second disc of magnetic material is made of low carbon steel.

9. The controlled descent device of claim 1, having a first configuration in which the first plurality of magnets and the second plurality of magnets are phased at a first phase angle and a second configuration in which the first plurality of magnets and the second plurality of magnets are phased at a second phase angle, the second phase angle being different from the first phase angle.

10. A method of induction braking in a controlled descent device, comprising,
providing a controlled descent device, the controlled descent device comprising,
a capstan mounted upon a rotatable shaft having a central axis,
a non-ferrous, electrically conductive plate joined to the rotatable shaft, the conductive plate having a first side and a second side,
a first plurality of magnets mounted on a first brake housing mounted in a first spaced relationship with the first side of the conductive plate and a second plurality of magnets mounted on a second brake housing mounted in a second spaced relationship with the second side of the conductive plate, wherein the first brake housing and the second brake housing are independently joined to the rotatable shaft and the second brake housing is rotatably joined to the rotatable shaft, and
wherein the first plurality of magnets and the second plurality of magnets are mounted in a radial configuration about the central axis and further wherein in a first configuration the first plurality of magnets and the second plurality of magnets are phased at a first phase angle and in a second configuration the first plurality of magnets and the second plurality of magnets are phase at second phase angle, the second phase angle being different from the first phase angle,
rotating the capstan about the central axis, and
rotating the second brake housing to move the first plurality of magnets and the second plurality of magnets from the first configuration to the second configuration.

11. The method of induction braking in a controlled descent device of claim 10, wherein the conductive plate is in a shape of a disc.

12. The method of induction braking in a controlled descent device of claim 10, wherein the first plurality of magnets are mounted on the first brake housing by being joined to a first disc of magnetic material, the first disc of magnetic material being joined to the first brake housing.

13. The method of induction braking in a controlled descent device of claim 10, wherein the second plurality of magnets are mounted on the second brake housing by being joined to a second disc of magnetic material, the second disc of magnetic material being joined to the second brake housing.

14. The method of induction braking in a controlled descent device of claim 10, wherein the first plurality of magnets comprises three stationary magnets, each of the three stationary magnets having a north and a south pole, the three stationary magnets being mounted radially and equally spaced about the central axis.

15. The method of induction braking in a controlled descent device of claim 10, wherein the second plurality of magnets comprises three rotatable magnets, each of the three rotatable magnets having a north and a south pole, the three rotatable magnets being mounted radially and equally spaced about the central axis.

16. The method of induction braking in a controlled descent device of claim 12, wherein the first disc of magnetic material is made of low carbon steel.

17. The method of induction braking in a controlled descent device of claim 13, wherein the second disc of magnetic material is made of low carbon steel.
